(19) United States
(12) Patent Application Publication
(10) Pub. No.: US 2025/0220668 A1
(43) Pub. Date: Jul. 3, 2025

(54) USING PRE-CONFIGURED TRANSMISSION OCCASIONS IN TRANSMISSION OF VARYING SIZED DATA IN MOBILE COMMUNICATIONS

(71) Applicant: MediaTek Singapore Pte. Ltd., Singapore (SG)

(72) Inventors: Pradeep JOSE, Cambridge (GB); Mehmet KUNT, Cambridge (GB); Ming-Yuan CHENG, Hsinchu City (TW)

(21) Appl. No.: 18/844,922

(22) PCT Filed: May 22, 2023
(86) PCT No.: PCT/CN2023/095430

§ 371 Date: Sep. 6, 2024

Related U.S. Application Data
(60) Provisional application No. 63/355,152, filed on Jun. 24, 2022.

(51) Int. Cl. H04W 72/21

(52) U.S. Cl. CPC H04W 72/21

(57) ABSTRACT

Techniques and solutions pertaining to using pre-configured transmission occasions in transmission of varying sized data in mobile communications are described. An apparatus (e.g., user equipment (UE)) receives a configuration from a network configuring a set of CG resources. The apparatus transmits an indication to the network indicating a number of CG resources of the set of CG resources used (or unused) in transmission in an occasion.

### CROSS REFERENCE TO RELATED PATENT APPLICATION(S)

The present disclosure is part of a non-provisional application claiming the priority benefit of U.S. Patent Application No. 63/355,152, filed 24 Jun. 2022, the content of which herein being incorporated by reference in its entirety.

### TECHNICAL FIELD

The present disclosure is generally related to mobile communications and, more particularly, to techniques of using pre-configured transmission occasions in transmission of varying sized data in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), applications such as extended reality (XR) and augmented reality (AR) tend to generate traffics for transmission with varying sized data. For instance, in a stream of time-sensitive media data for an XR/AR application, there may be frames of different sizes. One approach to enable such a stream of time-sensitive data to be quickly transmitted between a user equipment (UE) and a network involves the use of configured grants (CG resources) without scheduling delays. Conventionally, CG resources have been used for periodic traffics for which the sizes of data are known. However, how to utilize CG resources in transmission of varying sized data remains to be defined. Therefore, there is a need for a solution of using pre-configured transmission occasions in transmission of varying sized data in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving using pre-configured transmission occasions in transmission of varying sized data in mobile communications. It is believed that, under the various proposed schemes, aforementioned issues may be avoided, reduced or otherwise alleviated.

In one aspect, a method may involve a UE receiving a configuration from a network configuring a set of CG resources. The method may also involve the UE transmitting an indication to the network indicating a number of CG resources of the set of CG resources used (or unused) in transmission in an occasion.

In another aspect, an apparatus implementable in a UE may include a transceiver configured to communicate wirelessly and a processor coupled to the transceiver. The processor may receive a configuration from a network configuring a set of CG resources. The processor may transmit an indication to the network indicating a number of CG resources of the set of CG resources used (or unused) in transmission in an occasion.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a block diagram of an example communication system in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to using pre-configured transmission occasions in transmission of varying sized data in mobile communications. According to the present disclosure, a number of possible solutions may be implemented separately or jointly. That is, although these possible solutions may be described below separately, two or more of these possible solutions may be implemented in one combination or another.

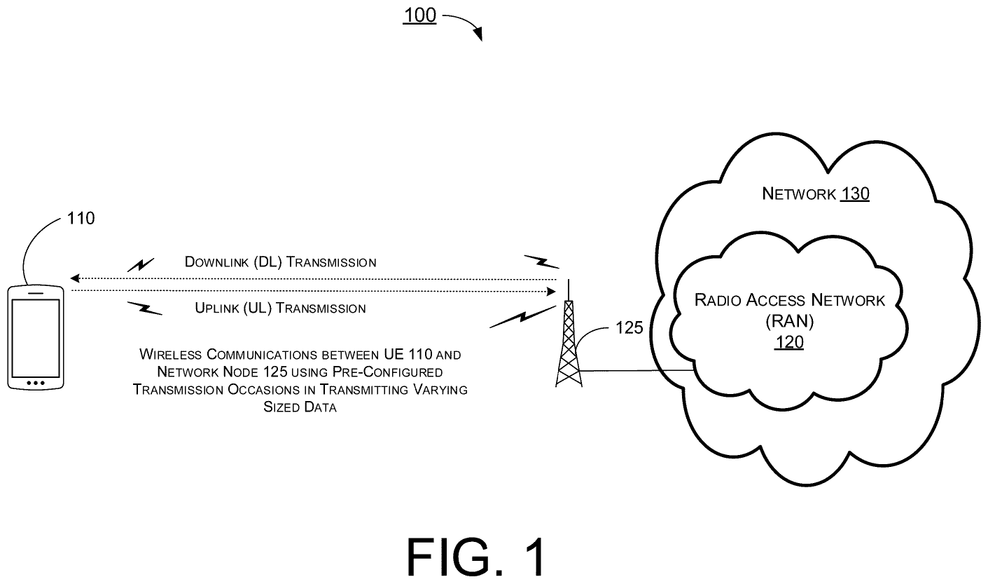

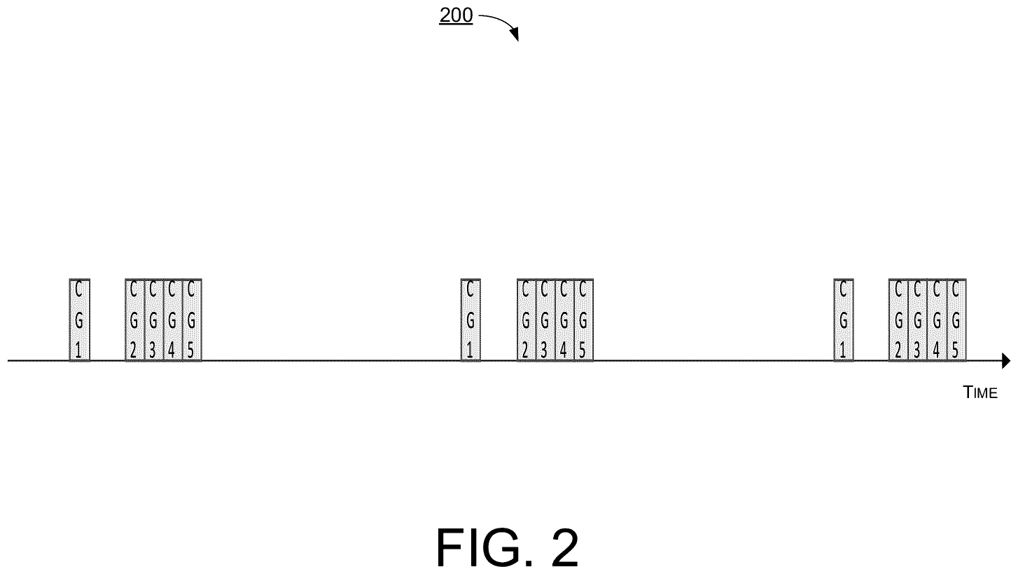

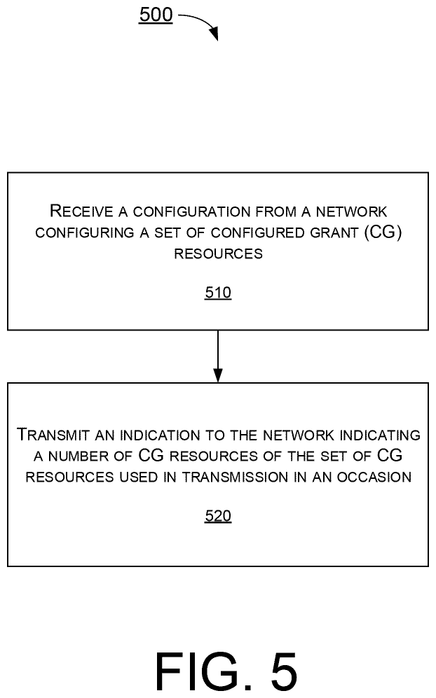

FIG. 1 illustrates an example network environment 100 in which various solutions and schemes in accordance with the present disclosure may be implemented. FIG. 2˜FIG. 5 illustrate examples of implementation of various proposed schemes in network environment 100 in accordance with the present disclosure. The following description of various proposed schemes is provided with reference to FIG. 1˜FIG. 5.

Referring to FIG. 1, network environment 100 may involve a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB or transmit-receive point (TRP)). RAN 120 may be a part of a network 130. In network environment 100, UE 110 and network 130 (via network node 125 of RAN 120) may implement various schemes pertaining to using pre-configured transmission occasions in transmission of varying sized data in mobile communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

Under a proposed scheme in accordance with the present disclosure, a set of CG resources may be introduced or otherwise configured by network 130 for use by UE 110 for each of one or more occasions. Multiple CG resources in a given set may be separate out in the time domain. With varying sized data pending to be transmitted, at times, all CG resources corresponding to the multiple CG resources in a given set in a given occasion may be used for transmission while, at other times, one or few (but not all) CG resources corresponding to one or few (but not all) of the multiple CG resources in the set of CG resources may be used for transmission. Accordingly, under the proposed scheme, when UE 110 performs a transmission on a first CG resource of a set of multiple CG resources, UE 110 may indicate to network 130 how many CG resources (or how many remaining CG resources) of the set of CG resources will be used by UE 110. As a corollary, UE 110 may indicate to network 130 how many CG resources of the set of CG resources will be unused by UE 110. Under the proposed scheme, some or all of the CG resources in a set of CG resources in each occasion may be spaced out in time, while others may be back to back in time (with no time gap therebetween).

For instance, in case that UE 110 is pre-configured with a set of five CG resources (e.g., CG1, CG2, CG3, CG4 and CG5) and for a given traffic UE 110 is to only the first three CG resources (namely, CG1˜CG3), UE 110 may indicate such to network 130. Upon receiving this indication from UE 110, network 130 may repurpose the unused CG resources and allocate the unused CG resources (namely, CG4 and CG5) to one or more other UEs. As another example, when UE 110 determines that it is to use up all CG resources in the set of CG resources in a given occasion, UE 110 may indicate such to network 130. Correspondingly, network 130 may not allocate any of the CG resources in that set of CG resources to any other UE. Advantageously, it is believed that the proposed scheme may provide flexibility and enhance performance while ensuring efficiency in resource usage.

FIG. 2 illustrates an example scenario 200 under a proposed schemes in accordance with the present disclosure. Referring to FIG. 2, under the proposed scheme, a respective set of CG resources in each occasion may be configured or scheduled by network 130 for use by UE 110. Each set of CG resources in each occasion may include a first CG resource (CG1) followed by one or more additional CG resources (e.g., four CG resources in the example shown in FIG. 2, such as CG2˜CG5, although the number may differ in actual implementations of the proposed scheme). There may be a time gap between a transmission using the first CG resource and another transmission using the second CG resource so as to provide sufficient gap of time for network 130 to process the indication provided by UE 110 (e.g., indicating how many CG resources in a given set of CG resources to be used by UE 110) and reschedule/allocate any unused CG resource(s) to other UE(s).

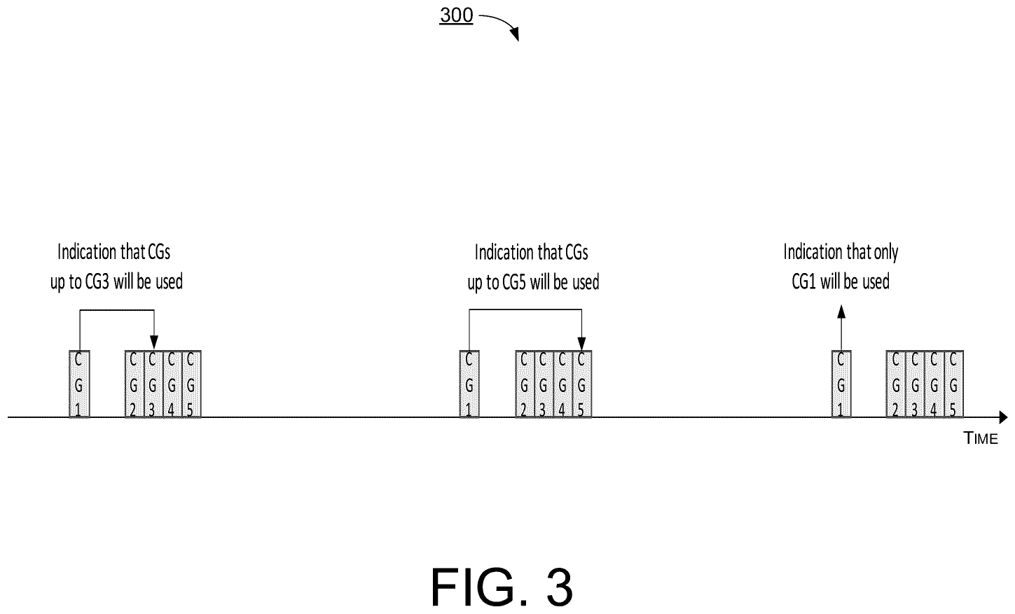

FIG. 3 illustrates an example scenario 300 under a proposed schemes in accordance with the present disclosure. Referring to FIG. 3, under the proposed scheme, UE 110 may indicate the number of CG resource(s) to be used by UE 110. In the example shown in part (A) of FIG. 3, the number indicated by UE 110 to network 130 is 3, meaning three CG resources (or up to CG3) are to be used by UE 110. In the example shown in part (B) of FIG. 3, the number indicated by UE 110 to network 130 is 5, meaning five CG resources (or up to CG5) are to be used by UE 110. In the example shown in part (C) of FIG. 3, the number indicated by UE 110 to network 130 is 1, meaning one CG resource (only CG1) is to be used by UE 110.

In another embodiment, the UE 110 may indicate the number of CG resource(s) to be unused by UE 110. In the example shown in part (A) of FIG. 3, the number indicated by UE 110 to network 130 is 2, meaning two CG resources (from CG4 to CG5) are to be unused by UE 110, then network 130 can reschedule/allocate two unused CG resources (CG4˜CG5) to other UE(s), wherein the CG resource of three CG resources (CG1˜CG3) is or is not to be used by UE 110. In the example shown in part (B) of FIG. 3, the number indicated by UE 110 to network 130 is 0, or there is no indication by UE 110 to network 130, meaning none of the CG resources which network 130 can reschedule/allocate to other UE(s). In the example shown in part (C) of FIG. 3, the number indicated by UE 110 to network 130 is 4, meaning four CG resources (from CG2 to CG5) are unused by UE 110, then network 130 can reschedule/allocate four unused CG resources (CG2˜CG5) to other UE(s), wherein one CG resource (only CG1) is or is not to be used by UE 110.

Under a proposed scheme in accordance with the present disclosure, the indication provided by UE 110 may be provided along with the transmission by UE 110 using a first CG resource (CG1) in the set of CG resources in each occasion. For instance, the transmission using the first CG resource may include a uplink control information (UCI), medium access control (MAC) control element (CE) or another form of indication to indicate the number of CG resources in the set of CG resources in a respective occasion to be used (or unused) by UE 110. For instance, a configured grant UCI (CG-UCI) may be repurposed for UE 110 to transmit the indication to network 130.

Under a proposed scheme in accordance with the present disclosure, the indication provided by UE 110 may be provided along with the transmission by UE 110 using each CG resource on which transmission is performed by UE 110. For instance, in an event that UE 110 is to use five CG resources in a given occasion, the indication of the number of CG resources used (or unused) by UE 110 may be provided in each transmission of five transmissions by UE 110 using the five CG resources. Advantageously, this may improve reliability in ensuring that network 130 receives this indication.

Under a proposed scheme in accordance with the present disclosure, the indication provided by UE 110 may be in the form of a physical-layer buffer status report (BSR). Moreover, the indication may provide coarse data information (e.g., frame size) in a granularity level of a CG grant size.

Under a proposed scheme in accordance with the present disclosure, all CG resources in a set of CG resources in a respective occasion may have the same size. Alternatively, the CG resources in a set of CG resources in a respective occasion may have different sizes. For instance, the first CG resource may be relatively smaller in size while other CG resources in the set of CG resources may be relatively larger in size.

Under a proposed scheme in accordance with the present disclosure, a last-CG indication may be provided by UE 110 to indicate to network 130 which CG resource in a set of CG resources in a respective occasion is the last CG resource used by UE 110 for transmission in that occasion. For instance, a one-bit indication may be sent along with a transmission by UE 110 on the CG resource being used. As an example, a value of “0” of the one-bit indication may indicate that the respective CG resource is not the last CG resource in the set of CG resources used by UE 110. Conversely, a value of “1” of the one-bit indication may indicate that the respective CG resource is the last CG resource in the set of CG resources in the respective occasion used by UE 110. Upon receiving this indication, network 130 may repurpose and allocate any remaining CG resource(s) to other UE(s).

Under a proposed scheme in accordance with the present disclosure, a countdown indication may be provided by UE 110 to indicate to network 130 how many CG resources that will be used by UE 110 in a respective occasion still remain. Upon receiving this indication, network 130 may repurpose and allocate any remaining CG resource(s) to other UE(s).

### Illustrative Implementations

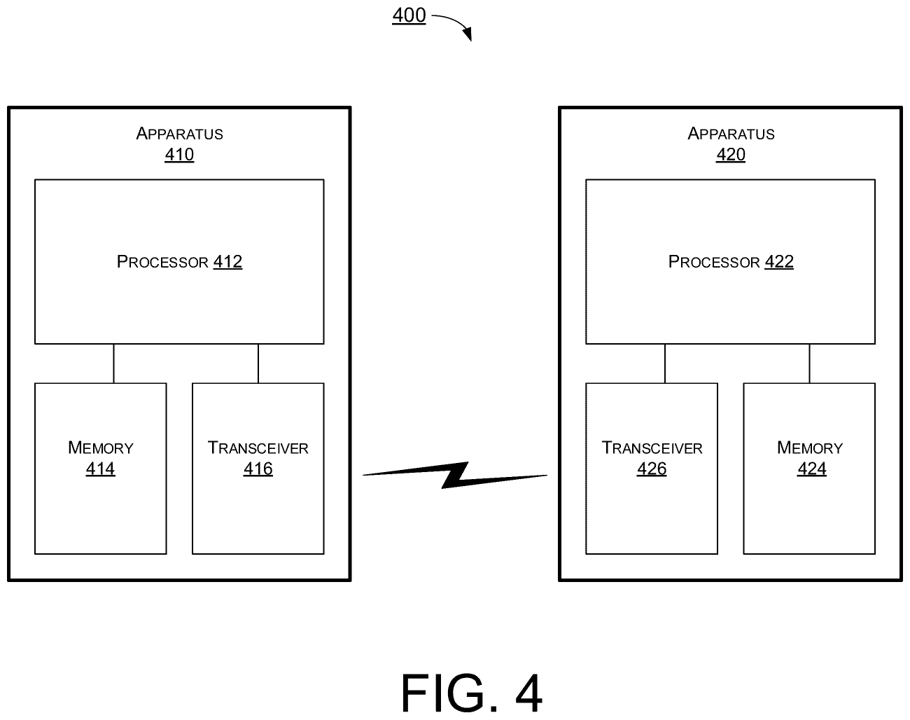

FIG. 4 illustrates an example communication system 400 having at least an example apparatus 410 and an example apparatus 420 in accordance with an implementation of the present disclosure. Each of apparatus 410 and apparatus 420 may perform various functions to implement schemes, techniques, processes and methods described herein pertaining to using pre-configured transmission occasions in transmission of varying sized data in mobile communications, including the various schemes described above with respect to various proposed designs, concepts, schemes, systems and methods described above, including network environment 100, as well as processes described below.

Each of apparatus 410 and apparatus 420 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 410 and apparatus 420 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 410 and apparatus 420 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 410 and apparatus 420 may be implemented in a smart thermostat, a smart fridge, a smart door lock, a wireless speaker or a home control center. When implemented in or as a network apparatus, apparatus 410 and/or apparatus 420 may be implemented in an eNodeB in an LTE, LTE-Advanced or LTE-Advanced Pro network or in a gNB or TRP in a 5G network, an NR network or an IoT network.

In some implementations, each of apparatus 410 and apparatus 420 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 410 and apparatus 420 may be implemented in or as a network apparatus or a UE. Each of apparatus 410 and apparatus 420 may include at least some of those components shown in FIG. 4 such as a processor 412 and a processor 422, respectively, for example. Each of apparatus 410 and apparatus 420 may further include one or more other components not pertinent to the proposed scheme of the present disclosure (e.g., internal power supply, display device and/or user interface device), and, thus, such component(s) of apparatus 410 and apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC or RISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to using pre-configured transmission occasions in transmission of varying sized data in mobile communications in accordance with various implementations of the present disclosure.

In some implementations, apparatus 410 may also include a transceiver 416 coupled to processor 412. Transceiver 416 may be capable of wirelessly transmitting and receiving data. In some implementations, transceiver 416 may be capable of wirelessly communicating with different types of wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs/wireless networks of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of apparatus 410 and apparatus 420 may be a communication entity capable of communicating with each other using various proposed schemes in accordance with the present disclosure. For illustrative purposes and without limitation, a description of capabilities of apparatus 410, as a UE (e.g., UE 110), and apparatus 420, as a network node (e.g., network node 125 or another network node implementing one or more network-side functionalities described above) of an application server side network (e.g., network 130 as a 5G/NR mobile network), is provided below.

Under various proposed schemes in accordance with the present disclosure pertaining to using pre-configured transmission occasions in transmission of varying sized data in mobile communications, processor 412 of apparatus 410, implemented in or as a UE (e.g., UE 110) may receive, via transceiver 416, a configuration from a network (e.g., network 130 via apparatus 420 as network node 125) configuring a set of CG resources. Moreover, processor 412 may transmit, via transceiver 416, an indication to the network indicating a number of CG resources of the set of CG resources used (or unused) in transmission in an occasion.

In some implementations, in transmitting the indication, processor 412 may transmit the indication to indicate the number of CG resources used (or unused) in transmission of varying sized data in the occasion.

In some implementations, in transmitting the indication, processor 412 may transmit the indication using a first CG resource (or a last CG resource or each CG resource) of the set of CG resources to indicate the number of CG resources via a UCI.

In some implementations, in transmitting the indication, processor 412 may transmit the indication using a first CG resource (or a last CG resource or each CG resource) of the set of CG resources to indicate the number of CG resources via a MAC CE.

In some implementations, in transmitting the indication, processor 412 may transmit the indication via a CG-UCI.

In some implementations, in transmitting the indication, processor 412 may transmit the indication using each CG resource of the number of CG resources used (or unused) in the occasion.

In some implementations, in transmitting the indication, processor 412 may transmit a last-CG indication to indicate whether a respective CG resource on which the last-CG indication is transmitted is a last CG resources of the set of CG resources to be used.

In some implementations, in transmitting the indication, processor 412 may transmit a countdown value indicating a number of one or more CG resources of the set of CG resources remaining to be used.

In some implementations, the indication may be in a form of a physical-layer BSR. In some implementations, the indication may provide coarse data information (e.g., a frame size) in a granularity level of a CG grant size.

In some implementations, all CG resources in the set of CG resources may be of a same size. Alternatively, a size of a first CG resource in the set of CG resources may be different (e.g., smaller or larger) than that of one or more other CG resources in the set of CG resources.

In some implementations, some or all CG resources in the set of CG resources may be separated out in time. In some implementations, at least two CG resources in the set of CG resources may be adjacent to each other back to back with no time gap therebetween.

In some implementations, processor 412 may also transmit, via transceiver 416, a stream of varying sized data (e.g., from an XR/AR application) using the indicated number of CG resources.

### Illustrative Processes

FIG. 5 illustrates an example process 500 in accordance with an implementation of the present disclosure. Process 500 may represent an aspect of implementing various proposed designs, concepts, schemes, systems and methods described above, whether partially or entirely, including those pertaining to those described above. More specifically, process 500 may represent an aspect of the proposed concepts and schemes pertaining to using pre-configured transmission occasions in transmission of varying sized data in mobile communications. Process 500 may include one or more operations, actions, or functions as illustrated by one or more of blocks 510 and 520.

Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 410 and apparatus 420 as well as any variations thereof. Solely for illustrative purposes and without limiting the scope, process 500 is described below in the context of apparatus 410 as a UE (e.g., UE 110) and apparatus 420 as a communication entity such as a network node or base station (e.g., network node 125 or another network node implementing one or more network-side functionalities described above) of an application server side network (e.g., network 130). Process 500 may begin at block 510.

At 510, process 500 may involve processor 412 of apparatus 410, implemented in or as a UE (e.g., UE 110) receiving, via transceiver 416, a configuration from a network (e.g., network 130 via apparatus 420 as network node 125) configuring a set of CG resources. Process 500 may proceed from 510 to 520.

At 520, process 500 may involve processor 412 transmitting, via transceiver 416, an indication to the network indicating a number of CG resources of the set of CG resources used (or unused) in transmission in an occasion.

In some implementations, in transmitting the indication, process 500 may involve processor 412 transmitting the indication to indicate the number of CG resources used (or unused) in transmission of varying sized data in the occasion.

In some implementations, in transmitting the indication, process 500 may involve processor 412 transmitting the indication using a first CG resource (or a last CG resource or each CG resource) of the set of CG resources to indicate the number of CG resources via a UCI.

In some implementations, in transmitting the indication, process 500 may involve processor 412 transmitting the indication using a first CG resource (or a last CG resource or each CG resource) of the set of CG resources to indicate the number of CG resources via a MAC CE.

In some implementations, in transmitting the indication, process 500 may involve processor 412 transmitting the indication via a CG-UCI.

In some implementations, in transmitting the indication, process 500 may involve processor 412 transmitting the indication using each CG resource of the number of CG resources used (or unused) in the occasion.

In some implementations, in transmitting the indication, process 500 may involve processor 412 transmitting a last-CG indication to indicate whether a respective CG resource on which the last-CG indication is transmitted is a last CG resources of the set of CG resources to be used (or unused).

In some implementations, in transmitting the indication, process 500 may involve processor 412 transmitting a countdown value indicating a number of one or more CG resources of the set of CG resources remaining to be used.

In some implementations, the indication may be in a form of a physical-layer BSR. In some implementations, the indication may provide coarse data information (e.g., a frame size) in a granularity level of a CG grant size.

In some implementations, all CG resources in the set of CG resources may be of a same size. Alternatively, a size of a first CG resource in the set of CG resources may be different (e.g., smaller or larger) than that of one or more other CG resources in the set of CG resources.

In some implementations, some or all CG resources in the set of CG resources may be separated out in time. In some implementations, at least two CG resources in the set of CG resources may be adjacent to each other back to back with no time gap therebetween.

In some implementations, process 500 may further involve processor 412 transmitting, via transceiver 416, a stream of varying sized data (e.g., from an XR/AR application) using the indicated number of CG resources.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
receiving, by a processor of a user equipment (UE), a configuration from a network configuring a set of configured grant (CG) resources; and
transmitting, by the processor, an indication to the network indicating a number of CG resources of the set of CG resources used or unused in transmission in an occasion.

2. The method of claim 1, wherein the transmitting of the indication comprises transmitting the indication to indicate the number of CG resources used in transmission of varying sized data in the occasion.

3. The method of claim 1, wherein the transmitting of the indication comprises transmitting the indication using a first CG resource of the set of CG resources used in an occasion.

4. The method of claim 1, wherein the transmitting of the indication comprises transmitting the indication using each CG resource of the set of CG resources used in the occasion.

5. The method of claim 1, wherein the indication is indicated via a uplink control information (UCI).

6. The method of claim 1, wherein the indication is indicated via a medium access control (MAC) control element (CE).

7. The method of claim 1, wherein the indication is indicated via a CG uplink control information (CG-UCI).

8. The method of claim 1, wherein the transmitting of the indication comprises transmitting a last-CG indication to indicate whether a respective CG resource on which the last-CG indication is transmitted is a last CG resources of the set of CG resources to be used.

9. The method of claim 1, wherein the transmitting of the indication comprises transmitting a countdown value indicating a number of one or more CG resources of the set of CG resources remaining to be used.

10. The method of claim 1, wherein the indication is in a form of a physical-layer buffer status report (BSR).

11. The method of claim 1, wherein the indication provides coarse data information, including a frame size, in a granularity level of a CG grant size.

12. The method of claim 1, wherein all CG resources in the set of CG resources are of a same size.

13. The method of claim 1, wherein a size of a first CG resource in the set of CG resources is different than that of one or more other CG resources in the set of CG resources.

14. The method of claim 1, wherein some or all CG resources in the set of CG resources are separated out in time.

15. (canceled)

16. The method of claim 1, further comprising:
transmitting, by the processor, a stream of varying sized data using the indicated number of CG resources.

17. An apparatus implementable in a user equipment (UE), comprising:
a transceiver configured to communicate wirelessly; and
a processor coupled to the transceiver and configured to perform, via the transceiver, operations comprising:
receiving, via the transceiver, a configuration from a network configuring a set of configured grant (CG) resources; and
transmitting, via the transceiver, an indication to the network indicating a number of CG resources of the set of CG resources used in transmission in an occasion.

18. The apparatus of claim 17, wherein the transmitting of the indication comprises transmitting the indication using a first CG resource of the set of CG resources to indicate the number of CG resources via a uplink control information (UCI), a medium access control (MAC) control element (CE) or a CG-UCI.

19. The apparatus of claim 17, wherein the transmitting of the indication comprises transmitting the indication using each CG resource of the number of CG resources used in the occasion.

20. The apparatus of claim 17, wherein the transmitting of the indication comprises transmitting a last-CG indication to indicate whether a respective CG resource on which the last-CG indication is transmitted is a last CG resources of the set of CG resources to be used.

21. The apparatus of claim 17, wherein the transmitting of the indication comprises transmitting a countdown value indicating a number of one or more CG resources of the set of CG resources remaining to be used.
